(19) United States
(12) Patent Application Publication
(10) Pub. No.: US 2006/0208566 A1
(43) Pub. Date: Sep. 21, 2006

(54) Braking force control apparatus of wheeled vehicle

(75) Inventor: Nobuyuki Ohtsu, Kanagawa (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 11/374,154

(22) Filed: Mar. 14, 2006

(30) Foreign Application Priority Data
Mar. 15, 2005 (JP) 2005-073940

(51) Int. Cl. B60T 8/32

(52) U.S. Cl. 303/191

(57) ABSTRACT

In a braking force control apparatus of a wheeled vehicle employing a vehicle sensor capable of detecting at least a slope in a longitudinal direction of the vehicle, and a hydraulic modulator regulating a wheel-brake cylinder pressure of each of front and rear road wheels, a control unit is configured to be electronically connected to the vehicle sensor and the hydraulic modulator, for independently controlling the wheel-brake cylinder pressure of the front road wheel and the wheel-brake cylinder pressure of the rear road wheel by respective control rules, different from each other. When a first one of the two different control rules is applied to the front road wheel, the control unit applies the second control rule to the rear road wheel. Conversely when the second control rule is applied to the front road wheel, the control unit applies the first control rule to the rear road wheel.

### TECHNICAL FIELD

The present invention relates to a braking force control apparatus of a wheeled vehicle, and specifically to the improvement of a braking force control technology for a wheeled vehicle employing a slope traveling control system, in particular, a hill-descent control (HDC) system capable of achieving a controlled descent of a hill without the need for the driver to apply the brakes, thus realizing stable vehicle traveling on descending the hill.

### BACKGROUND ART

In recent years, there have been proposed and developed various hill-descent control (HDC) technologies. In a braking force control apparatus of a wheeled vehicle provided with a HDC system, in order to bring an actual wheel speed closer to a desired wheel speed based on an accelerator opening, a brake-fluid-pressure command value for each of wheel-brake cylinders is generally calculated by way of proportional-plus-integral-plus-derivative (PID) control, in which the control signal is a linear combination of the error signal, its integral, and its derivative. One such HDC-system equipped wheeled vehicle has been disclosed in International Publication Number WO96/11826 corresponding to Japanese Patent Provisional Publication No. 10-507145. Front-engine, front-wheel-drive (FF) vehicles, generally use a so-called diagonal split layout of brake circuits (sometimes termed “X-split layout”), in which one part of the tandem master cylinder output is connected via a first brake pipeline (a primary brake circuit) to front-left and rear-right wheel-brake cylinders and the other part is connected via a second brake pipeline (a secondary brake circuit) to front-right and rear-left wheel-brake cylinders. In automotive vehicles with such an X-split layout of brake circuits, when a wheel-brake cylinder pressure of a rear road wheel associated with one of the primary and secondary brake circuits is reduced during a pressure build-up mode for a front road wheel associated with the same brake circuit, working fluid (brake fluid) is returned from the rear wheel-brake cylinder to a reservoir and the returned working fluid is pumped out, and then the pumped-out working fluid is fed to the front wheel-brake cylinder. As a result of this, the fluid pressure in the front wheel-brake cylinder would be further built up. As discussed above, there is an increased tendency for the front-wheel fluid pressure control and the rear-wheel fluid pressure control to interfere with each other. Thus, it is difficult to accurately control the front wheel-brake cylinder pressure and the rear wheel-brake cylinder pressure independently of each other in such an X-split layout, when the rear road wheel associated with one of the primary and secondary brake circuits is operated in the pressure reduction mode and simultaneously the front road wheel associated the same brake circuit is operated in the pressure build-up mode. On the contrary, assuming that the front and rear road wheels included in the same brake circuit are simultaneously operated in their pressure build-up mode, a large amount of working fluid has to be supplied and thus the fluid-pressure control responsiveness may be deteriorated. One way of avoiding this is to hold a desired rear-wheel fluid pressure value at “0” and additionally to achieve braking force application by way of only the front-wheel fluid pressure control. However, suppose that a wheeled vehicle, having a HDC system and an X-split brake circuit layout, is in a hill-descent control mode (a hill descent mode) and additionally application of the brakes is achieved by only the front-wheel braking pressure control. This leads to another problems, such as the increased operating noise produced by the braking system and undesirable brake fade phenomena caused by overheated brake pads and rotors.

### SUMMARY OF THE INVENTION

It is, therefore, in view of the previously-described disadvantages of the prior art, an object of the invention to provide a braking force control apparatus of a hill-descent control (HDC) system equipped vehicle, which is capable of suppressing front-wheel brake fluid pressure control and rear-wheel brake fluid pressure control from interfering with each other, and avoiding an increase in operating noise produced by a braking system and undesirable brake fade (a reduction of braking effectiveness) caused by overheating.

In order to accomplish the aforementioned and other objects of the present invention, a braking force control apparatus of a wheeled vehicle comprises a vehicle sensor that detects operating conditions of the vehicle, a hydraulic brake unit that regulates a wheel-brake cylinder pressure of each of front and rear road wheels, and a control unit configured to be electronically connected to the vehicle sensor and the hydraulic brake unit, for independently controlling the wheel-brake cylinder pressure of the front road wheel and the wheel-brake cylinder pressure of the rear road wheel by respective control rules, different from each other.

According to another aspect of the invention, a braking force control apparatus of a wheeled vehicle comprises vehicle sensor means for detecting operating conditions of the vehicle, hydraulic modulating means for regulating a wheel-brake cylinder pressure of each of front and rear road wheels, and control means configured to be electronically connected to the vehicle sensor means and the hydraulic modulating means, for executing, at least during a slope traveling state of the vehicle, a slope traveling control mode at which the wheel-brake cylinder pressure of the front road wheel and the wheel-brake cylinder pressure of the rear road wheel are independently controlled by respective control rules, different from each other.

According to a further aspect of the invention, a method of controlling a braking force of a wheeled vehicle by a hydraulic modulator regulating a wheel-brake cylinder pressure of each of front and rear road wheels, the method comprises independently controlling the wheel-brake cylinder pressure of the front road wheel and the wheel-brake cylinder pressure of the rear road wheel by respective control rules, different from each other, at least during a slope traveling state of the vehicle.

According to a still further aspect of the invention, a braking force control apparatus of a wheeled vehicle comprises a wheel speed sensor that detects a wheel speed of each of front and rear road wheels, a slope detector that detects a slope in a longitudinal direction of the vehicle, a hydraulic brake unit that regulates a wheel-brake cylinder pressure of each of the front and rear road wheels, a control unit having a first control rule, which is based on feedback control that the detected wheel speed is brought closer to a desired wheel speed and a second control rule, which is based on the slope detected by the slope detector, the control unit applying the second control rule to the rear road wheel, when the first control rule is applied to the front road wheel, and the control unit applying the first control rule to the rear road wheel, when the second control rule is applied to the front road wheel.

The other objects and features of this invention will become understood from the following description with reference to the accompanying drawings.

### BRIEF DESCRIPTION OF THE DRAWINGS

FIG. 1 is a system diagram illustrating an embodiment of a braking force control apparatus of a wheeled vehicle with a hill-descent control (HDC) system.

FIG. 2 is a hydraulic circuit diagram of a hydraulic brake unit incorporated in the braking force control apparatus of the embodiment.

FIG. 3 is a flow chart showing a basic control routine (or a main control program) for hill-descent control executed within the braking force control apparatus of the embodiment.

FIG. 4 is a flow chart showing desired wheel speed arithmetic processing corresponding to step S100 of FIG. 3.

FIG. 5 is a flow chart showing PID control signal arithmetic processing corresponding to step S200 of FIG. 3.

FIG. 6 is a flow chart showing controlled variable arithmetic processing for a PID-control based front-wheel controlled variable and a longitudinal-G based rear-wheel controlled variable, executed within the braking force control apparatus of the embodiment.

FIG. 7 is a flow chart showing a comparative example of controlled variable arithmetic processing according to which a front-wheel controlled variable is determined based on a PID control signal and a rear-wheel controlled variable is held at “0”.

FIG. 8 is a longitudinal-G XGF versus rear-wheel controlled variable PBS_HDC versus rear-wheel control mode characteristic diagram.

FIG. 9 is a conversion table of the rear-wheel control mode and rear-wheel controlled variable about longitudinal acceleration XGF, and related to FIG. 8.

FIG. 10 is a flow chart showing solenoid pressure build-up control processing corresponding to step S400 of FIG. 3.

FIG. 11 is a flow chart showing solenoid pressure reduction control processing corresponding to step S500 of FIG. 3.

FIG. 12 is a flow chart showing solenoid pressure hold control processing corresponding to step S600 of FIG. 3.

FIGS. 13A-13E are time charts explaining the difference between hill-descent control executed by the braking force control apparatus of the embodiment and using the controlled variables determined by the arithmetic processing of FIG. 6 and hill-descent control using the controlled variables determined by the arithmetic processing of FIG. 7.

### DESCRIPTION OF THE PREFERRED EMBODIMENTS

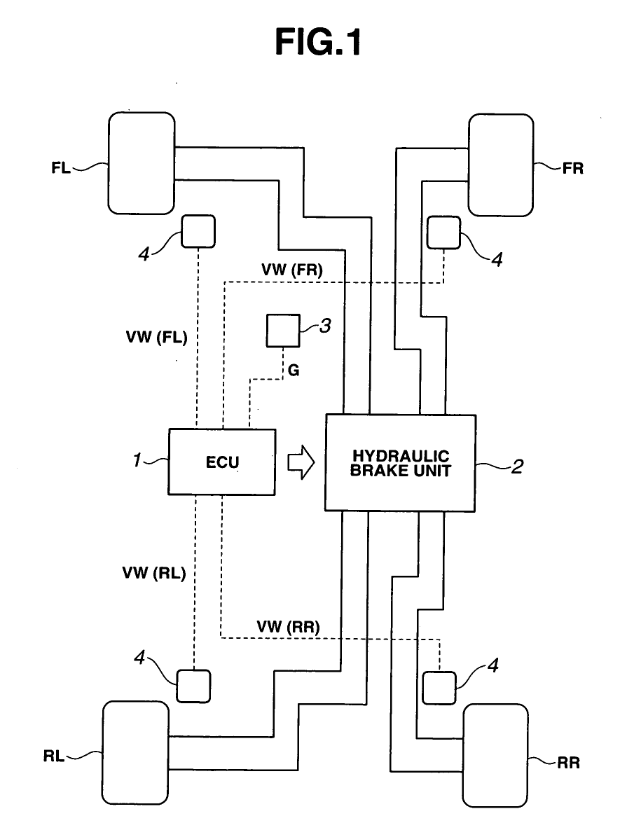

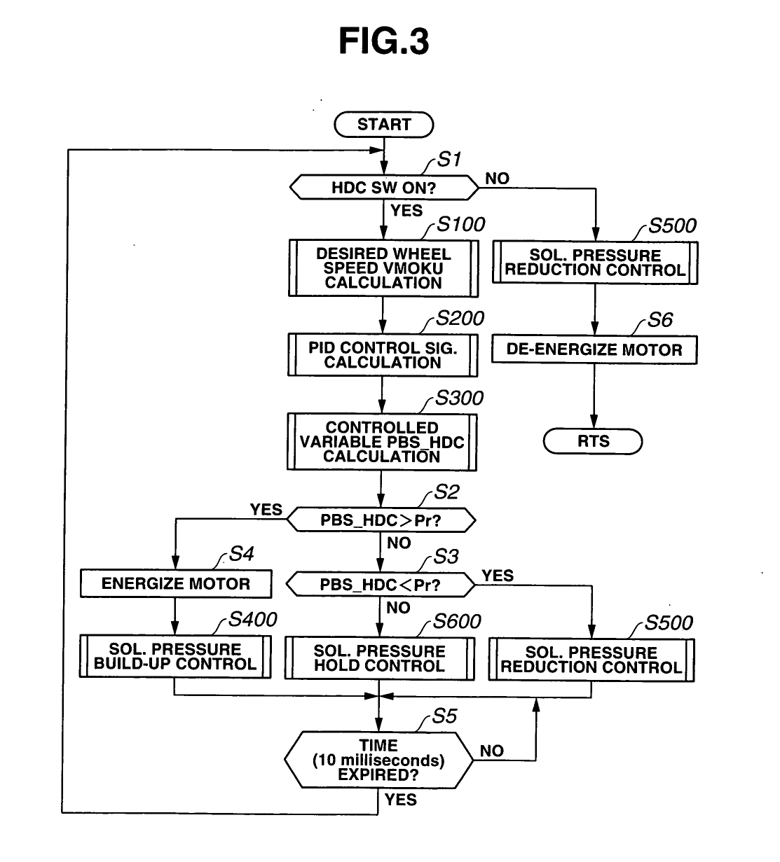

Referring now to the drawings, particularly to FIG. 1, there is shown the system diagram of the braking force control apparatus of the embodiment. The braking force control apparatus of the embodiment is exemplified in a four-wheeled vehicle employing a hill-descent control (HDC) system and a so-called diagonal split layout of brake circuits (an X-split brake circuit layout). As clearly shown in FIG. 1, four major operating components are employed with the braking force control apparatus, and these are an electronic control unit (ECU) 1, a hydraulic brake unit (or a hydraulic modulator or a hydraulic modulating means) 2, an acceleration sensor 3 (exactly, a longitudinal G sensor) serving as a slope detector that detects a steepness of a slope or a gradient of a road surface in the longitudinal direction of the vehicle, and wheel speed sensors 4, 4, 4, 4, respectively located at front-left, front-right, rear-left, and rear-right road wheels FL, FR, RL, RR. ECU 1 generally comprises a microcomputer. ECU 1 includes an input/output interface (I/O), memories (RAM, ROM), and a microprocessor or a central processing unit (CPU). The input/output interface (I/O) of ECU 1 receives input information from various engine/vehicle switches and sensors, namely a longitudinal acceleration detected by longitudinal G sensor 3, and front-left, front-right, rear-left, and rear-right wheel speeds VW(FL), VW(FR), VW(RL), and VW(RR) detected by wheel speed sensors 4. Front-left, front-right, rear-left, and rear-right wheel speeds VW(FL), VW(FR), VW(RL), and VW(RR) are collectively referred to as “VW”. Within ECU 1, the central processing unit (CPU) allows the access by the I/O interface of input informational data signals from the previously-discussed sensors 3 and 4. The CPU of ECU 1 estimates a steepness of the slope based on the detected slope (the signal from slope detector 3). The CPU of ECU 1 is responsible for carrying the hill-descent control program (described later in reference to FIGS. 3-6 and 8-11) stored in memories and is capable of performing necessary arithmetic and logic operations. Computational results (arithmetic calculation results), that is, calculated output signals (control command signals) are relayed through the output interface circuitry of ECU 1 to output stages, namely solenoid valves of hydraulic brake unit 2 included in the braking force control apparatus, so as to optimally control a braking force applied to each of the road wheels FL, FR, RL, and RR. In the shown embodiment, the longitudinal acceleration exerted on the vehicle is detected by means of longitudinal G sensor 3. In lieu thereof, a pseudo vehicle speed VSP is estimated or derived from the detected wheel speeds, and then the longitudinal acceleration may be calculated as a differentiation value dVSP/dt of the estimated pseudo vehicle speed.

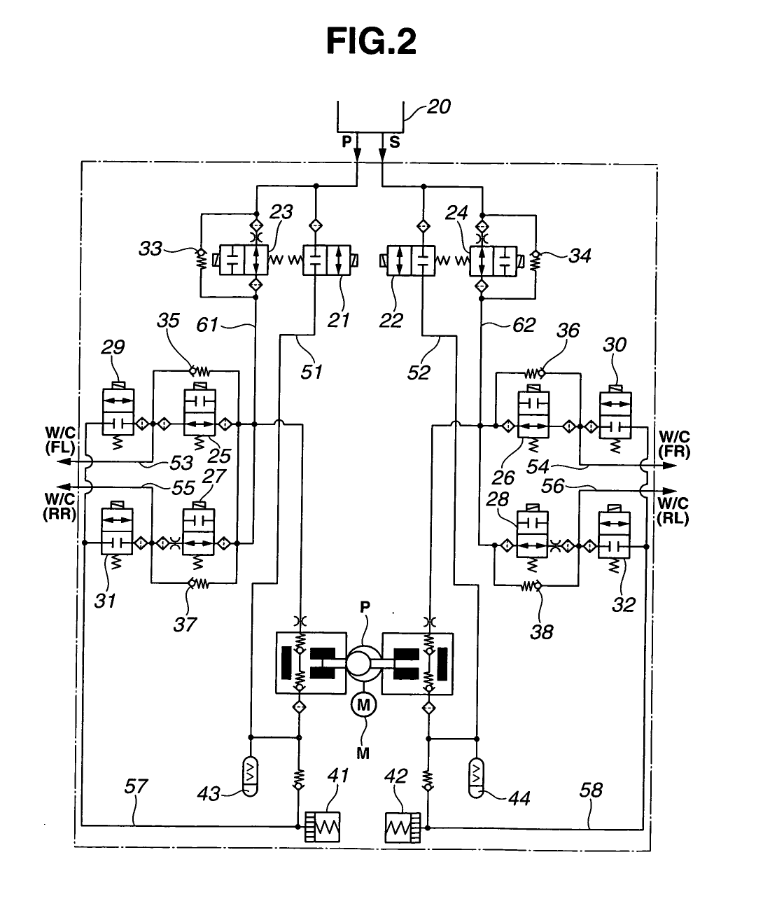

Referring now to FIG. 2, there is shown the hydraulic circuit diagram of hydraulic brake unit 2. Brake unit 2 is comprised of a tandem hydraulic circuit or a dual brake system having a primary brake circuit (a P brake circuit) and a secondary brake circuit (an S brake circuit) functioning independently, and a tandem master cylinder 20 with two pistons, set in tandem. In the shown embodiment, a hydraulic pump P is constructed by a unidirectional dual-plunger pump. Another type of hydraulic pump may be used as pump P. Pump P is driven by an electric motor M. Regarding the pump inlet side, the first inlet port of pump P is connected through a brake fluid line 51 and a normally-closed inflow gate valve 21 to the primary outlet port of master cylinder 20, whereas the second inlet port of pump P is connected through a brake fluid line 52 and a normally-closed inflow gate valve 22 to the secondary outlet port of master cylinder 20. Regarding the pump outlet side, the first outlet port of pump P is connected through inflow valves 25 and 27 and brake fluid lines 53 and 55 to front-left and rear-right wheel-brake cylinders W/C(FL) and W/C(RR), whereas the second outlet port of pump P is connected through inflow valves 26 and 28 and brake fluid lines 54 and 56 to front-right and rear-left wheel-brake cylinders W/C(FR) and W/C(RL).

Fluid lines 53 and 55 are connected through outflow valves 29 and 31 and a brake fluid line 57 to a reservoir 41, and also connected to the first inlet port of pump P together with the fluid line 51. Fluid lines 54 and 56 are connected through outflow valves 30 and 32 and a brake fluid line 58 to a reservoir 42, and also connected to the second inlet port of pump P together with the fluid line 52. The ports of inflow valves 25 and 27, connected to the first pump outlet port, is also connected through a brake fluid line 61 and a normally-open outflow gate valve 23 to the primary master-cylinder outlet port. Likewise, the ports of inflow valves 26 and 28, connected to the second pump outlet port, is also connected through a brake fluid line 62 and a normally-open outflow gate valve 24 to the secondary master-cylinder outlet port. A check valve (a one-way directional control valve) 33 is provided in parallel with outflow gate valve 23, to permit free flow in one direction and to prevent any backflow in the opposite direction (toward the primary outlet port of master cylinder 20). In a similar manner, a check valve (a one-way directional control valve) 34 is provided in parallel with outflow gate valve 24, to permit free flow in one direction and to prevent any backflow in the opposite direction (toward the secondary outlet port of master cylinder 20). Check valves 35 and 37 are provided in parallel with respective inflow valves 25 and 27, so as to prevent any backflow toward respective wheel-brake cylinders W/C(FL) and W/C(RR). In a similar manner, check valves 36 and 38 are provided in parallel with respective inflow valves 26 and 28, so as to prevent any backflow toward respective wheel-brake cylinders W/C(FR) and W/C(RL). A primary-circuit diaphragm pressure accumulator 43, simply a first diaphragm, is connected to fluid line 51 and disposed between inflow gate valve 21 and the first outlet port of pump P, whereas a secondary-circuit diaphragm pressure accumulator 44, simply a second diaphragm, is connected to fluid line 52 and disposed between inflow gate valve 22 and the second outlet port of pump P. The previously-noted hydraulic circuit (brake unit 2) operates as follows.

(During Pressure Build-Up Mode)

During a pressure build-up mode, inflow gate valves 21-22 and inflow valves 25-28 are kept at their valve-open positions, while outflow valves 29-32 are kept at their valve-closed positions. Under these conditions, pump P is driven. During rotation of pump P, working fluid (brake fluid) is pumped out of master cylinder 20. The pumped-out working fluid is fed through fluid lines 51-52 and 53-56 into respective wheel-brake cylinders W/C(FL), W/C(RR), W/C(FR), and W/C(RL), so as to create a pressure build-up in each wheel-brake cylinder.

(During Pressure Reduction Mode)

During a pressure reduction mode, inflow valves 25-28 are kept at their valve-closed positions, while outflow valves 29-32 are kept at their valve-open positions. As a result, working fluid in each of wheel-brake cylinders W/C(FL) and W/C(RR) is returned to reservoir 41 and at the same time working fluid in each of wheel-brake cylinders W/C(FR) and W/C(RL) is returned to reservoir 42, so as to create a pressure reduction in each wheel-brake cylinder.

Referring to FIG. 3, there is shown the main HDC control routine executed within the braking force control apparatus of the embodiment. The HDC control routine of FIG. 3 is executed as time-triggered routines to be triggered every predetermined time intervals such as 10 milliseconds. Hereunder described are the detailed arithmetic and logic operations of each of steps S1-S6, and S100-S600.

At step S1, a check is made to determine whether a HDC control switch is turned ON. When the answer to step S1 is affirmative (YES), that is, the HDC control switch is turned ON and thus a request for hill-descent control is present, the routine proceeds to step S100. Conversely when the answer to step S1 is negative (NO), that is, the HDC control switch is turned OFF and thus a request for hill-descent control is absent, the routine proceeds to step S500.

At step S100, a desired wheel speed VMOKU suitable for a HDC control mode (a hill descent mode) is arithmetically calculated. Thereafter, step S200 occurs.

At step S200, the PID control signal arithmetic processing is executed. Concretely, a deviation between the desired wheel speed arithmetically calculated and the actual wheel speed detected, that is, an error signal is calculated. Additionally, a derivative of the deviation (i.e., a derivative of the error signal) and an integral of the deviation (i.e., an integral of the error signal) are calculated. Thereafter, step S300 occurs.

At step S300, a controlled variable of front-left road wheel FL and a controlled variable of front-right road wheel FR are arithmetically calculated and determined by way of a control rule based on feedback control (in the shown embodiment, PID control). On the other hand, a controlled variable of rear-left road wheel RL and a controlled variable of rear-right road wheel RR are arithmetically calculated and determined by way of a control rule based on the G sensor signal from longitudinal G sensor 3 but not based on PID control. Thereafter, the routine proceeds from step S300 to step S2.

At step S2, a check is made to determine whether the front-wheel controlled variable calculated through step S300, that is, the controlled variable PBS_HDC for each of front-left and front-right wheel-brake cylinder pressures, is greater than an actual brake fluid pressure Pr in each of front wheel-brake cylinders W/C (FL) and W/C (FR). When the answer to step S2 is affirmative (YES), that is, PBS_HDC>Pr, the processor of ECU 1 determines that the actual fluid pressure in each of front wheel-brake cylinders W/C(FL) and W/C(FR) is insufficient, and thereafter the routine flows to step S4. Conversely when the answer to step S2 is negative (NO), that is, PBS_HDC<Pr, the routine proceeds from step S2 to step S3.

At step S3, another check is made to determine whether the front-wheel controlled variable calculated through step S300, that is, the controlled variable PBS_HDC for each of front-left and front-right wheel-brake cylinder pressures, is less than the actual front wheel-brake fluid pressure Pr. When the answer to step S3 is affirmative (YES), that is, PBS_HDC<Pr, the processor of ECU 1 determines that the actual fluid pressure in each of front wheel-brake cylinders W/C(FL) and W/C(FR) is excessively high, and thereafter the routine flows to step S500, so as to initiate a pressure reduction control mode. Conversely when the answer to step S3 is negative (NO), that is, PBS_HDC>Pr, the routine proceeds from step S3 to step S600, so as to initiate a pressure hold control mode.

At step S4, to prepare for the pressure build-up mode, motor M is energized and driven. Thereafter, the routine proceeds from step S4 to step S400.

At step S400, front-wheel pressure build-up control is executed in accordance with the controlled variables of front-left and front-right wheels FL and FR, arithmetically calculated and determined by way of the control rule based on PID control. Thereafter, step S5 occurs.

At step S500, front-wheel pressure reduction control is executed in accordance with the controlled variables of front-left and front-right wheels FL and FR, arithmetically calculated and determined by way of the control rule based on PID control. Thereafter, step S5 occurs.

At step S600, front-wheel pressure hold control is executed, and thereafter step S5 occurs.

At step S5, a check is made to determine whether the elapsed time, measured or counted from the starting point of the current execution cycle of HDC control, reaches the predetermined time interval, for example, 10 milliseconds. When the answer to step S5 is affirmative (YES), the routine returns from step S5 to step S1, to initiate the next execution cycle. Conversely when the answer to step S5 is negative (NO), the elapsed time is continuously measured.

After the flow from step S1 to step S500, step S6 occurs. At step S6, motor M is de-energized, and thus one execution cycle of HDC control terminates.

[Desired Wheel Speed Arithmetic Processing]

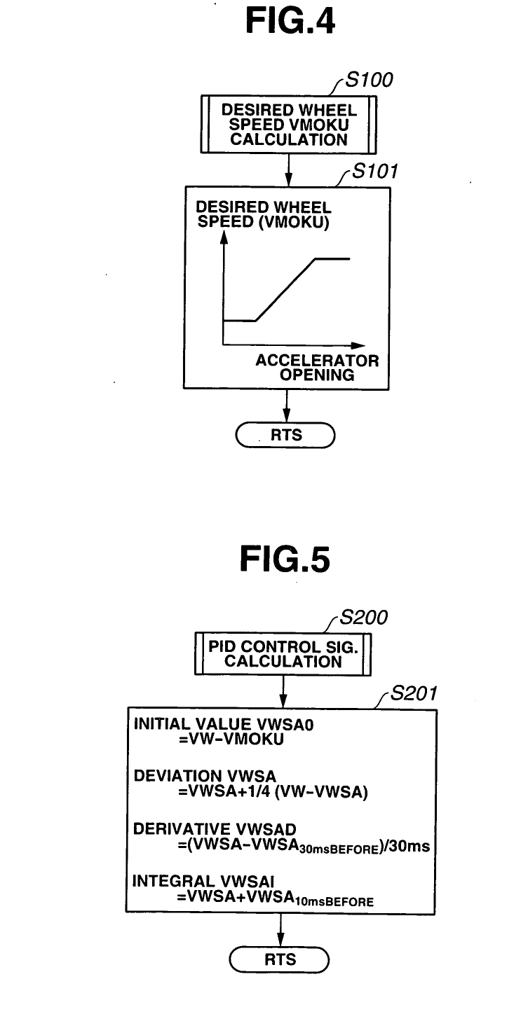

Referring to FIG. 4, there is shown the desired wheel speed arithmetic processing, which corresponds to step S100 of the main HDC control routine of FIG. 3.

At step S101, desired wheel speed VMOKU for HDC control is map-retrieved or computed based on an accelerator opening from a preprogrammed accelerator-opening versus desired wheel speed VMOKU characteristic map. Thereafter, the subroutine of FIG. 4 returns to step S200 of the main program of FIG. 3.

[PID Control Signal Arithmetic Processing]

Referring to FIG. 5, there is shown the PID control signal arithmetic processing, which corresponds to step S200 of the main HDC control routine of FIG. 3.

At step S201, four signals needed for PID control are arithmetically calculated or computed based on the difference between the desired output and the actual output, that is, the deviation between the desired wheel speed arithmetically calculated and the actual wheel speed detected. More concretely, an initial value VWSA0 of a deviation between a desired wheel speed VMOKU and an actual wheel speed VW, a deviation VWSA, a derivative VWSAD of the deviation VWSA, and an integral VWSAI of the deviation VWSA are calculated from the following expressions.
VWSA0=VW−VMOKU
VWSA=VWSA+¼(VW−VWSA)
VWSAD=(VWSA−VWSA_{30msBEFORE})/30 ms
VWSAI=VWSA+VWSA_{10msBEORE}
where VWSA_{30msBEFORE} denotes the deviation calculated 30 milliseconds before (in other words, three execution cycles before), and VWSA_{10msBEFORE} denotes the deviation calculated 10 milliseconds before (in other words, one execution cycle before).
[Controlled Variable Arithmetic Processing]

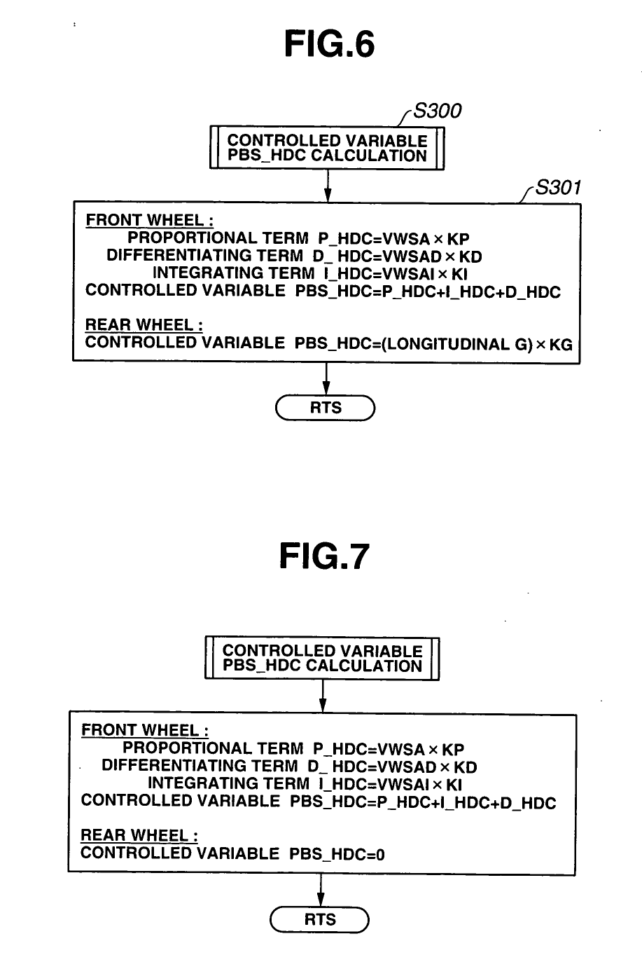

Referring now to FIG. 6, there is shown the controlled variable arithmetic processing, which corresponds to step S300 of the main HDC control routine of FIG. 3, and is executed within the braking force control apparatus of the embodiment.

At step S301, the controlled variable PBS_HDC of the front wheel side FL, FR is arithmetically calculated and determined by way of a control rule based on PID control. Concretely, the front-wheel controlled variable PBS_HDC is calculated based on the deviation VWSA, its derivative VWSAD, and its integral VWSAI, all calculated through step S201. As can be appreciated from the following expressions, the front-wheel controlled variable PBS_HDC is determined as a summed value of a proportional term P_HDC obtained by multiplying the deviation VWSA with a gain KP, a differentiating term D_HDC obtained by multiplying the derivative VWSAD with a gain KD, and an integrating term I_HDC obtained by multiplying the integral VWSAI with a gain KI. Based on the calculated controlled variable PBS_HDC of PID control, each of front wheel speeds VW(FL) and VW(FR) is brought closer to the desired wheel speed VMOKU.
P_{—}HDC=VWSA×KP
D_{—}HDC=VWSAD×KD
I_{—}HDC=VWSAI×KI
PBS_{—}HDC=P_{—}HDC+I_{—}HDC+D_{—}HDC=VWSA×KP+VWSAI×KI+VWSAD×KD

In the shown embodiment, as appreciated from the hydraulic diagram of FIG. 2, the four-wheeled vehicle uses the X-split brake circuit layout, in which one part of the tandem master cylinder output is connected via the primary brake circuit to front-left and rear-right wheel-brake cylinders W/C(FL) and W/C(RR) and the other part is connected via the secondary brake circuit to front-right and rear-left wheel-brake cylinders W/C(FR) and W/C(RL). In the four-wheeled vehicle with such an X-split layout of brake circuits, suppose that the front and rear road wheels are operated at two different fluid-pressure operating modes, namely the pressure build-up mode and the pressure reduction mode. For instance, assuming that, on descending the hill, front road wheels FL and FR are conditioned in their pressure build-up modes and rear road wheels RL and RR are conditioned in their pressure reduction modes, front-left and front-right wheel-brake cylinder pressures Pr_W/C(FL) and Pr_W/C(FR) are built up by working fluid pumped out of master cylinder 20. On the other hand, working fluid in rear-left wheel-brake cylinder W/C(RL) is returned into reservoir 41 of the primary circuit side, whereas working fluid in rear-right wheel-brake cylinder W/C(RR) is returned into reservoir 42 of the secondary circuit side. The returned working fluid is utilized to create a pressure build-up in each of front-left and front-right wheel-brake cylinders W/C(FL) and W/C(FR). As a result, there is an increased tendency for front wheel-brake cylinder pressures Pr_W/C(FL) and Pr_W/C(FR) to be excessively built up. This leads to the problem of the undesired interference of front-wheel braking pressure control and rear-wheel braking pressure control. To avoid this, in the comparative example shown in FIG. 7, the front-wheel controlled variable is determined based on the PID control signal and the rear-wheel controlled variable is held at “0”. That is, in the comparative example of FIG. 7, in order to avoid undesired interference of front-wheel braking pressure control and rear-wheel braking pressure control, only the front wheel-brake cylinder pressures Pr_W/C(FL) and Pr_W/C(FR) are controlled by way of PID control in such a manner as to create a pressure build-up in each of the front wheel-brake cylinders, whereas desired fluid pressure values for rear wheel-brake cylinder pressures Pr_W/C(RL) and Pr_W/C(RR) are held or fixed to “0”. Front-left, front-right, rear-let, and rear-right wheel-brake cylinder pressures Pr_W/C(FL), Pr_W/C(FR), Pr_W/C(RL), and Pr_W/C(RR) are collectively referred to as “Pr_W/C”. However, in the comparative example of FIG. 7, there is no braking force application to each of rear road wheels RL, RR and additionally application of the brakes is achieved by only the front-wheel braking pressure control. Thus, the load on the front-wheel braking system is so hard, thereby resulting in another problems, for example, the increased operating noise produced by the front-wheel braking system and undesirable brake fade phenomena caused by overheating.

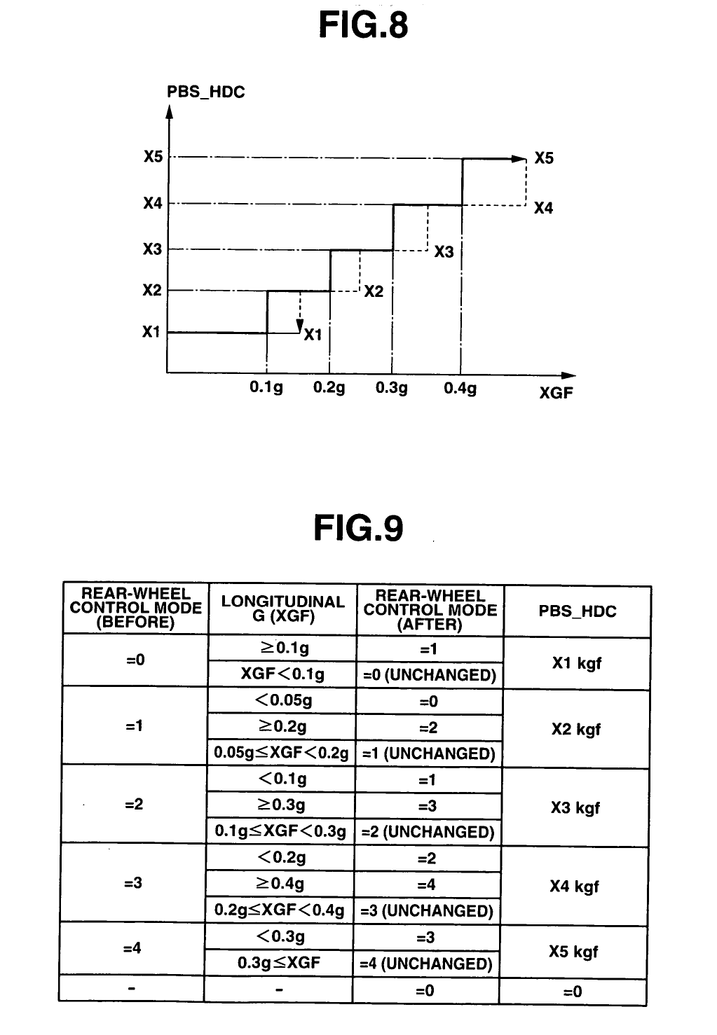

On the contrary, according to the braking force control apparatus of the embodiment, as can be appreciated from FIG. 6, regarding the brakes of the front wheel side, during the hill descent mode, front wheel-brake cylinder pressures Pr_W/C(FL) and Pr_W/C(FR) are controlled by way of PID control in a similar manner to the comparative example of FIG. 7. On the other hand, as can be appreciated from FIGS. 6, 8, and 9, regarding the brakes of the rear wheel side, during the hill descent mode, each of rear wheel-brake cylinder pressures Pr_W/C(RL) and Pr_W/C(RR) is operated at either the pressure build-up mode or the pressure hold mode, but not operated at the pressure reduction mode. In other words, the control rule for the brakes of the rear wheel side is programmed to execute only a selected one of wheel-brake cylinder pressure build-up control and wheel-brake cylinder pressure hold control, while inhibiting wheel-brake cylinder pressure reduction control. Additionally, as can be seen from the preprogrammed characteristic diagram of FIG. 8 and the longitudinal G (XGF) versus rear-wheel control mode conversion table of FIG. 9, the rear-wheel control mode (=0; =1; =2; =3; =4) for each of rear wheel-brake cylinders W/C(RL) and W/C(RR) is determined or set based on the longitudinal acceleration value XGF detected by longitudinal G sensor 3, in a stepwise manner. Additionally, the rear-wheel pressure build-up controlled variable PBS_HDC is arithmetically calculated or determined as a product (PBS_HDC=XGF×KG) obtained by multiplying the detected longitudinal acceleration value XGF with a gain KG, for every rear-wheel control mode (=0; =1; =2; =3; =4). Therefore, the rear-wheel controlled variable PBS_HDC changes stepwise depending on the detected longitudinal acceleration value XGF (see FIGS. 8-9).

According to the braking force control apparatus of the embodiment, the braking force of the front wheel side and the braking force of the rear wheel side can be produced in accordance with respective control rules, different from each other, independently, and additionally during the hill descent mode, each of the rear wheels are operated at either the pressure build-up mode or the pressure hold mode, but not operated at the pressure reduction mode. This avoids the undesired interference between front-wheel pressure build-up control and rear-wheel pressure reduction control, thus reducing the load on the front-wheel braking system.

Regarding the rear wheel-brake cylinder pressure control, suppose that a mode shift from one of a plurality of rear-wheel control modes (=0, =1, =2, =3, =4) to the other frequently occurs. Such a frequent mode shift leads to another problems, such as a large amount of working fluid delivered according to the fluid pressure control, and frequent variations in the rear-wheel controlled variable, increased electric power consumption (deteriorated fuel economy), and deteriorated controllability. To avoid undesirable hunting and to suppress undesirably frequent mode shift and to improve the controllability, a hysteresis is provided in a mode shift from one of the two adjacent rear-wheel control modes (two adjacent rear wheel-brake cylinder pressure control modes) to the other (see FIGS. 8-9). In the shown embodiment, the controlled variable of each of front wheels FL, FR is determined by way of the control rule (i.e., PBS_HDC=P_HDC+I_HDC+D_HDC) based on PID control, and the controlled variable of each of rear wheels RL, RR is determined by way of the control rule (i.e., PBS_HDC=XGFXKG) based on the longitudinal G sensor signal. In lieu thereof, as a modification, the controlled variable of each of front wheels FL, FR may be determined by way of the control rule (i.e., PBS_HDC=XGFXKG) based on the longitudinal G sensor signal, and the controlled variable of each of rear wheels RL, RR may be determined by way of the control rule (i.e., PBS_HDC=P_HDC+I_HDC+D_HDC) based on PID control.

[Solenoid Pressure Build-Up Control]

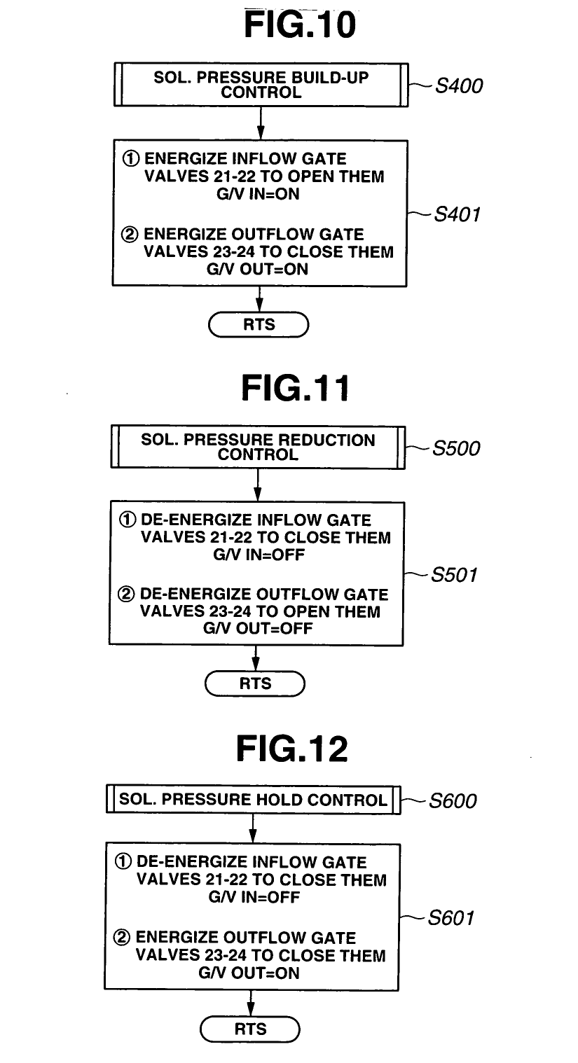

Referring to FIG. 10, there is shown the solenoid pressure build-up control processing, which corresponds to step S400 of the main HDC control routine of FIG. 3.

At step S401, electromagnetic solenoids of normally-closed inflow gate valve (abbreviated to “G/V IN”) 21 and normally-closed inflow gate valve 22 are both energized so as to fully open them. At the same time, electromagnetic solenoids of normally-open outflow gate valve (abbreviated to “G/V OUT”) 23 and normally-open outflow gate valve 24 are both energized so as to fully close them. Thereafter, the subroutine of FIG. 10 returns to step S5 of the main program of FIG. 3.

[Solenoid Pressure Reduction Control]

Referring to FIG. 11, there is shown the solenoid pressure reduction control processing, which corresponds to step S500 of the main HDC control routine of FIG. 3.

At step S501, the electromagnetic solenoids of normally-closed inflow gate valves 21 and 22 are both de-energized so as to fully close them. At the same time, the electromagnetic solenoids of normally-open outflow gate valves 23 and 24 are both de-energized so as to fully open them. Thereafter, the subroutine of FIG. 11 returns to either step S5 or step S6 of the main program of FIG. 3.

[Solenoid Pressure Hold Control]

Referring to FIG. 12, there is shown the solenoid pressure hold control processing, which corresponds to step S600 of the main HDC control routine of FIG. 3.

At step S601, the electromagnetic solenoids of normally-closed inflow gate valves 21 and 22 are both de-energized so as to fully close them. At the same time, the electromagnetic solenoids of normally-open outflow gate valves 23 and 24 are both energized so as to fully close them. Thereafter, the subroutine of FIG. 12 returns to step S5 of the main program of FIG. 3.

[Variations in Wheel Speeds and Wheel Cyl. Pressures During HDC Control Mode]

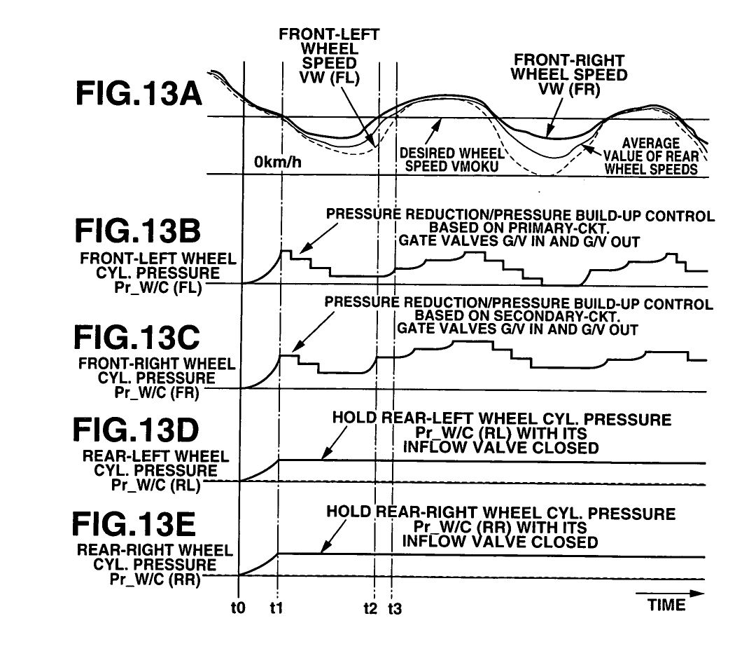

Referring now to FIGS. 13A-13E, there are shown the time charts explaining the difference between (i) hill-descent control executed by the control apparatus of the embodiment and using the controlled variables determined by the arithmetic processing of FIG. 6 and (ii) hill-descent control using the controlled variables determined by the arithmetic processing of FIG. 7. As described previously, regarding the brakes of the front wheel side, during the HDC control mode in the control apparatus of the embodiment, the front-wheel controlled variable PBS_HDC for each of front wheels FL, FR is determined based on PID control in a similar manner to the comparative example of FIG. 7. On the other hand, regarding the brakes of the rear wheel side, during the hill descent mode in the control apparatus of the embodiment, the rear-wheel controlled variable PBS_HDC for each of rear wheels RL, RR is determined based on the longitudinal G sensor signal. In contrast, in the comparatively example of FIG. 7, the rear-wheel controlled variable PBS_HDC is held at “0”. Thus, for the purpose of comparison between the control apparatus of the embodiment of FIG. 6 and the comparative example of FIG. 7, in the time charts of FIGS. 13D-13E, rear wheel cylinder pressures Pr_W/C(RL) and Pr_W/C(RR), determined based on the controlled variable arithmetic processing of the comparative example of FIG. 7 during the HDC control mode are indicated by the broken lines, whereas rear wheel cylinder pressures Pr_W/C(RL) and Pr_W/C(RR), determined based on the controlled variable arithmetic processing of the embodiment of FIG. 6 during the HDC control mode are indicated by the solid lines.

(TIME t0)

When a command for pressure build-up is output at the time t0, each of front wheel cylinder pressures Pr_W/C(FL) and Pr_W/C(FR) begins to rise. In the control apparatus of the embodiment, from the time t0, each of rear wheel-brake cylinder pressures Pr_W/C(RL) and Pr_W/C(RR) begins to rise (see the rear wheel-brake cylinder pressure rise indicated by the solid line in each of FIGS. 13D-13E), because of the control rule (i.e., PBS_HDC=XGFXKG) of step S301 of FIG. 6. In contrast, in the control apparatus of the comparative example of FIG. 7, from the time t0, each of rear wheel-brake cylinder pressures Pr_W/C(RL) and Pr_W/C(RR) is held or fixed to “0” (see the zero pressure indicated by the broken line in each of FIGS. 13D-13E), because of the arithmetic processing (i.e., PBS_HDC=1) of FIG. 7.

(TIME t1)

Assuming that at the time t1 each of actual front-left and front-right wheel speeds VW(FL) and VW(FR), detected by wheel speed sensors 4, becomes lower than desired wheel speed VMOKU, calculated through step S100 of FIG. 3, and thus pressure hold control for each front wheel FL, FR comes into operation. After execution of the pressure hold mode for a while, pressure reduction control comes into operation. In this manner, from the time t1, pressure hold control and pressure reduction control for each front wheel FL, FR are repeatedly executed, until each of actual front-left and front-right wheel speeds VW(FL) and VW(FR) becomes higher than desired wheel speed VMOKU.

(TIME t2)

Thereafter, assuming that at the time t2 actual front-right wheel speed VW(FR) exceeds desired wheel speed VMOKU, pressure reduction control for front-right wheel FR terminates. After this, a command for front-right wheel pressure build-up and a command for front-right wheel pressure hold are repeatedly output, until desired wheel speed VMOKU becomes reached again by actual front-right wheel speed VW(FR), i.e., VW(FR)<VMOKU. A time period from a time (see the time t1) when actual wheel speed VW becomes lower than desired wheel speed VMOKU via a time (see the time t2) when actual wheel speed VW exceeds desired wheel speed VMOKU after actual wheel speed VW became lower than desired wheel speed VMOKU to a time when actual wheel speed VW becomes lower than desired wheel speed VMOKU again, is regarded as one cycle of braking-pressure control (wheel-brake cylinder pressure control). During the cycle, pressure reduction control and pressure hold control for front-right wheel FR are repeatedly executed in accordance with the pressure-reduction/pressure-hold command, and then pressure build-up control and pressure hold control for front-right wheel FR are repeatedly executed in accordance with the pressure-build-up/pressure-hold command.

(TIME t3)

Thereafter, assuming that at the time t3 actual front-left wheel speed VW(FL) exceeds desired wheel speed VMOKU, pressure reduction control for front-left wheel FL terminates. After this, in a similar manner to the braking-pressure control executed with respect to front-right wheel FR, for every cycle, pressure reduction control and pressure hold control for front-left wheel FL are repeatedly executed in accordance with a pressure-reduction/pressure-hold command, and then pressure build-up control and pressure hold control for front-left wheel FL are repeatedly executed in accordance with the pressure-build-up/pressure-hold command.

As previously described, regarding braking-pressure control for each of rear wheels RL, RR, as indicated by the solid lines in FIGS. 13D-13E, in the control apparatus of the comparative example of FIG. 7, after the time t1 as well as during the time period (t0−t1), each of rear wheel-brake cylinder pressures Pr_W/C(RL) and Pr_W/C(RR) is continuously held or fixed to “o” and thus there is no braking force application to each of rear wheels RL, RR during the HDC control mode. On the other hand, in the control apparatus of the embodiment, during the time period (t0−t1) from the time t0 when the command for pressure build-up is output to the time t1 when the pressure-hold command is output, each of rear wheel cylinder pressures Pr_W/C(RL) and Pr_W/C(RR) rises, and after the time t1 each of rear wheel cylinder pressures Pr_W/C(RL) and Pr_W/C(RR) is held at a pressure value (>0) determined based on the control rule (i.e., PBS_HDC=XGFXKG) of step S301 of FIG. 6. In this manner, in accordance with the control rule of step S301 of FIG. 6, executed by the control apparatus of the embodiment, braking force application to each rear wheel RL, RR and braking force application to each front wheel FL, FR occur simultaneously during the HDC control mode. This reduces the load on the front-wheel braking system even during operation of the HDC control system, thereby avoiding an increase in operating noise produced by the braking system and undesirable brake fade (a reduction of braking effectiveness) caused by overheating, during the HDC control mode.

As will be appreciated from the above, in the braking force control apparatus of the embodiment, the braking force of the front wheel side and the braking force of the rear wheel side can be produced in accordance with respective control rules, different from each other, independently. For instance, assuming that a controlled variable for each of front wheels FL, FR is determined by a control rule based on PID control that actual wheel speed VW is brought closer to desired wheel speed VMOKU, a controlled variable for each of rear wheels RL, RR is determined by a control rule based on a longitudinal G sensor signal value XGF. Alternatively, assuming that a controlled variable for each of front wheels FL, FR is determined by a control rule based on a longitudinal G sensor signal value XGF, a controlled variable for each of rear wheels RL, RR is determined by a control rule based on PID control that actual wheel speed VW is brought closer to desired wheel speed VMOKU. As discussed above, according to the control apparatus of the embodiment, the braking force of the front wheel side and the braking force of the rear wheel side can be independently controlled by two different control rules, namely the control rule based on PID control and the control rule based on the longitudinal G sensor signal. Suppose that the control apparatus of the embodiment is applied to a four-wheeled vehicle with an X-split brake circuit layout. Even when a controlled variable for each front wheel FL, FR differs from a controlled variable for each rear wheel RL, RR in case of the X-split brake circuit layout, it is possible to avoid undesirable interference of front-wheel braking pressure control and rear-wheel braking pressure control. Additionally, when the front-wheel braking force is produced in accordance with a first control rule of the previously-noted two different control rules during the HDC control mode, the rear-wheel braking force is produced in accordance with the second control rule. By the occurrence of braking force applied to each rear wheel RL, RR as well as the occurrence of braking force applied to each front wheel FL, FR, it is possible to effectively reduce the load on the front-wheel braking system during hill descent control, thus ensuring the reduced operating noise of the braking system and suppressed brake fade.

Furthermore, according to the control apparatus of the embodiment, the rear-wheel control mode for each of rear wheel-brake cylinders W/C(RL) and W/C(RR) is set based on the detected longitudinal acceleration value XGF, in a stepwise manner (see the preprogrammed longitudinal-G XGF versus rear-wheel controlled variable PBS_HDC versus rear-wheel control mode characteristic diagram of FIG. 8). Additionally, the rear-wheel controlled variable PBS_HDC is arithmetically calculated as a product (PBS_HDC=XGFXKG) obtained by multiplying the detected longitudinal acceleration value XGF with gain KG, for every rear-wheel control mode (=0; =1; =2; =3; =4) (see the conversion table of FIG. 9). Note that a hysteresis is provided in a mode shift from one of the two adjacent rear-wheel control modes to the other (see FIGS. 8-9). The provision of such a hysteresis avoids or suppresses various problems, such as a large amount of working fluid delivered according to braking pressure control, and frequent variations in rear-wheel controlled variable PBS_HDC, increased electric power consumption (deteriorated fuel economy), and deteriorated controllability.

In the shown embodiment, rear-wheel controlled variable PBS_HDC is determined according to a control rule based on longitudinal G sensor signal value XGF in such a manner as to change stepwise depending on the detected longitudinal acceleration value. In lieu thereof, rear-wheel controlled variable PBS_HDC may be determined according to another control rule based on longitudinal G sensor signal value XGF, but functioning to continuously vary rear-wheel controlled variable PBS_HDC in accordance with a change (an increase/a decrease) in longitudinal acceleration value XGF.

Although, in the shown embodiment, one of the two different control rules is a control rule based on PID control that actual wheel speed VW is brought closer to desired wheel speed VMOKU, the PID control may be replaced by another feedback control such as proportional-plus-integral (PI) or proportional-plus-derivative (PD).

Although, in the shown embodiment, the inventive concept of the invention is applied to a four-wheeled vehicle employing a HDC system capable of achieving a controlled descent of a hill, it will be appreciated that the inventive concept may be applied to a two-wheeled vehicle employing a HDC system. Alternatively, the inventive concept may be applied to a wheeled vehicle employing front and rear wheels and a slope traveling control system capable of achieving a controlled descent of a downhill and/or a controlled ascent of an uphill.

The entire contents of Japanese Patent Application No. 2005-073940 (filed Mar. 15, 2005) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. A braking force control apparatus of a wheeled vehicle comprising:
a vehicle sensor that detects operating conditions of the vehicle;
a hydraulic brake unit that regulates a wheel-brake cylinder pressure of each of front and rear road wheels; and
a control unit configured to be electronically connected to the vehicle sensor and the hydraulic brake unit, for independently controlling the wheel-brake cylinder pressure of the front road wheel and the wheel-brake cylinder pressure of the rear road wheel by respective control rules, different from each other.

2. The braking force control apparatus as claimed in claim 1, wherein:
the vehicle sensor comprises a wheel speed sensor that detects a wheel speed of each of the front and rear road wheels, and a slope detector that detects a slope in a longitudinal direction of the vehicle; and
the control unit comprises a processor programmed to perform the following,
(a) determining a controlled variable of one of the front wheel-brake cylinder pressure and the rear wheel-brake cylinder pressure by a first one of the two different control rules, which is based on feedback control that the detected wheel speed is brought closer to a desired wheel speed; and
(b) determining a controlled variable of the other of the front wheel-brake cylinder pressure and the rear wheel-brake cylinder pressure by the second control rule, which is based on the slope detected by the slope detector.

3. The braking force control apparatus as claimed in claim 2, wherein:
the wheeled vehicle comprises a four-wheeled vehicle having an X-split layout of primary and secondary brake circuits, in which front-left and rear-right wheel-brake cylinders are connected via the primary brake circuit to each other, and front-right and rear-left wheel-brake cylinders are connected via the secondary brake circuit to each other.

4. The braking force control apparatus as claimed in claim 2, wherein said processor is further programmed for:
(c) applying the second control rule to the rear road wheel, when the first control rule is applied to the front road wheel.

5. The braking force control apparatus as claimed in claim 2, wherein said processor is further programmed for:
(c) applying the first control rule to the rear road wheel, when the second control rule is applied to the front road wheel.

6. The braking force control apparatus as claimed in claim 2, wherein:
the second control rule is programmed to execute, based on the slope detected by the slope detector, only a selected one of wheel-brake cylinder pressure build-up control and wheel-brake cylinder pressure hold control, while inhibiting wheel-brake cylinder pressure reduction control.

7. The braking force control apparatus as claimed in claim 2, wherein:
the slope detector comprises an acceleration sensor that detects a longitudinal acceleration exerted on the vehicle; and
the second control rule is programmed to execute a wheel-brake cylinder pressure control mode, based on the detected longitudinal acceleration, and further programmed to provide a hysteresis in a mode shift from one of two different wheel-brake cylinder pressure control modes to the other.

8. The braking force control apparatus as claimed in claim 3, wherein:
the processor is further programmed to estimate a steepness of the slope, based on the detected slope, and to set, in a stepwise manner, a plurality of controlled variables corresponding to a plurality of wheel-brake cylinder pressure control modes for the second control rule, depending on the estimated steepness of the slope.

9. The braking force control apparatus as claimed in claim 8, wherein:
the slope detector comprises an acceleration sensor that detects a longitudinal acceleration exerted on the vehicle; and
the second control rule is programmed to execute a wheel-brake cylinder pressure control mode, based on the detected longitudinal acceleration, and further programmed to provide a hysteresis in a mode shift from one of two different wheel-brake cylinder pressure control modes to the other.

10. The braking force control apparatus as claimed in claim 4, wherein:
the wheeled vehicle comprises a four-wheeled vehicle having an X-split layout of primary and secondary brake circuits, in which front-left and rear-right wheel-brake cylinders are connected via the primary brake circuit to each other, and front-right and rear-left wheel-brake cylinders are connected via the secondary brake circuit to each other.

11. The braking force control apparatus as claimed in claim 10, wherein:
the second control rule is programmed to execute, based on the slope detected by the slope detector, only a selected one of wheel-brake cylinder pressure build-up control and wheel-brake cylinder pressure hold control, while inhibiting wheel-brake cylinder pressure reduction control.

12. The braking force control apparatus as claimed in claim 11, wherein:
the slope detector comprises an acceleration sensor that detects a longitudinal acceleration exerted on the vehicle; and
the second control rule is programmed to execute a wheel-brake cylinder pressure control mode, based on the detected longitudinal acceleration, and further programmed to provide a hysteresis in a mode shift from one of two different wheel-brake cylinder pressure control modes to the other.

13. A braking force control apparatus of a wheeled vehicle comprising:
vehicle sensor means for detecting operating conditions of the vehicle;
hydraulic modulating means for regulating a wheel-brake cylinder pressure of each of front and rear road wheels; and
control means configured to be electronically connected to the vehicle sensor means and the hydraulic modulating means, for executing, at least during a slope traveling state of the vehicle, a slope traveling control mode at which the wheel-brake cylinder pressure of the front road wheel and the wheel-brake cylinder pressure of the rear road wheel are independently controlled by respective control rules, different from each other.

14. The braking force control apparatus as claimed in claim 13, wherein:
the vehicle sensor means comprises wheel speed sensor means for detecting a wheel speed of each of the front and rear road wheels, and slope detection means for detecting a slope in a longitudinal direction of the vehicle; and
the control means comprises a processor programmed to perform the following,
(a) determining a controlled variable of one of the front wheel-brake cylinder pressure and the rear wheel-brake cylinder pressure by a first one of the two different control rules, which is based on feedback control that the detected wheel speed is brought closer to a desired wheel speed; and
(b) determining a controlled variable of the other of the front wheel-brake cylinder pressure and the rear wheel-brake cylinder pressure by the second control rule, which is based on the slope detected by the slope detector.

15. The braking force control apparatus as claimed in claim 14, wherein:
the wheeled vehicle comprises a four-wheeled vehicle having an X-split layout of primary and secondary brake circuits, in which front-left and rear-right wheel-brake cylinders are connected via the primary brake circuit to each other, and front-right and rear-left wheel-brake cylinders are connected via the secondary brake circuit to each other.

16. The braking force control apparatus as claimed in claim 15, wherein said processor is further programmed for:
(c) applying the second control rule to the rear road wheel, when the first control rule is applied to the front road wheel.

17. The braking force control apparatus as claimed in claim 16, wherein:
the second control rule is programmed to execute, based on the slope detected by the slope detection means, only a selected one of wheel-brake cylinder pressure build-up control and wheel-brake cylinder pressure hold control, while inhibiting wheel-brake cylinder pressure reduction control.

18. The braking force control apparatus as claimed in claim 17, wherein:
the slope detection means comprises an acceleration sensor that detects a longitudinal acceleration exerted on the vehicle; and
the second control rule is programmed to execute a wheel-brake cylinder pressure control mode, based on the detected longitudinal acceleration, and further programmed to provide a hysteresis in a mode shift from one of two different wheel-brake cylinder pressure control modes to the other.

19. A method of controlling a braking force of a wheeled vehicle by a hydraulic modulator regulating a wheel-brake cylinder pressure of each of front and rear road wheels, the method comprising:
independently controlling the wheel-brake cylinder pressure of the front road wheel and the wheel-brake cylinder pressure of the rear road wheel by respective control rules, different from each other, at least during a slope traveling state of the vehicle.

20. A braking force control apparatus of a wheeled vehicle comprising:
a wheel speed sensor that detects a wheel speed of each of front and rear road wheels;
a slope detector that detects a slope in a longitudinal direction of the vehicle;
a hydraulic brake unit that regulates a wheel-brake cylinder pressure of each of the front and rear road wheels;
a control unit having a first control rule, which is based on feedback control that the detected wheel speed is brought closer to a desired wheel speed and a second control rule, which is based on the slope detected by the slope detector;
the control unit applying the second control rule to the rear road wheel, when the first control rule is applied to the front road wheel; and
the control unit applying the first control rule to the rear road wheel, when the second control rule is applied to the front road wheel.
